(19) United States
(12) Patent Application Publication
(10) Pub. No.: US 2026/0081668 A1
(43) Pub. Date: Mar. 19, 2026

(54) TECHNIQUES FOR PARTIAL CSI-RS RESOURCE-ELEMENT MAPPING

(71) Applicant: Lenovo (United States) Inc., Morrisville, NC (US)

(72) Inventor: Khaled Nafez Rauf Ardah, Ilmenau (DE)

(21) Appl. No.: 19/401,223

(22) Filed: Nov. 25, 2025

(51) Int. Cl. H04B 7/06; H04W 72/044

(52) U.S. Cl. CPC H04B 7/0626; H04W 72/044

(57) ABSTRACT

Various aspects of the present disclosure relate to techniques for partial CSI-RS RE mapping. An NE is configured to configure a CSI-RS resource comprising a plurality of CSI-RS ports grouped into one or more CDM groups; generate, for the CSI-RS resource, a configuration message comprising one or more indicators defining a partial resource element (RE) mapping in a time domain or a frequency domain, wherein the partial RE mapping specifies a quantity of REs for the at least one CDM group, wherein the quantity of REs is less than a quantity of CSI-RS ports of the at least one CDM group; and transmit the configuration message to a UE to enable the UE to receive and measure the CSI-RS according to the partial RE mapping.

### TECHNICAL FIELD

The present disclosure relates to wireless communications, and more specifically to techniques for partial channel state information reference signal (CSI-RS) resource-element (RE) mapping.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The devices (e.g., NE, UE) and methods of the present disclosure each have several innovative aspects, no single one of which is solely responsible for the desirable features disclosed herein.

A UE for wireless communication is described. The UE may be configured to, capable of, or operable to receive a configuration message configuring a CSI-RS resource comprising a plurality of CSI-RS ports grouped into one or more code-division multiplexing (CDM) groups, determine, from the configuration message, one or more indicators defining a partial RE mapping in a time domain or a frequency domain, wherein the partial RE mapping specifies a quantity of REs for at least one CDM group of the one or more CDM groups and wherein the quantity of REs is less than a quantity of CSI-RS ports of the at least one CDM group, receive the CSI-RS according to the partial RE mapping, and perform one or more CSI measurements based on the CSI-RS received according to the partial RE mapping.

A processor for wireless communication is described. The processor may be configured to, capable of, or operable to receive a configuration message configuring a CSI-RS resource comprising a plurality of CSI-RS ports grouped into one or more CDM groups, determine, from the configuration message, one or more indicators defining a partial RE mapping in a time domain or a frequency domain, wherein the partial RE mapping specifies a quantity of REs for at least one CDM group of the one or more CDM groups and wherein the quantity of REs is less than a quantity of CSI-RS ports of the at least one CDM group, receive the CSI-RS according to the partial RE mapping, and perform one or more CSI measurements based on the CSI-RS received according to the partial RE mapping.

A method for wireless communication performed by a UE is described. The method may be configured to, capable of, or operable to receive a configuration message configuring a CSI-RS resource comprising a plurality of CSI-RS ports grouped into one or more CDM groups, determine, from the configuration message, one or more indicators defining a partial RE mapping in a time domain or a frequency domain, wherein the partial RE mapping specifies a quantity of REs for at least one CDM group of the one or more CDM groups and wherein the quantity of REs is less than a quantity of CSI-RS ports of the at least one CDM group, receive the CSI-RS according to the partial RE mapping, and perform one or more CSI measurements based on the CSI-RS received according to the partial RE mapping.

An NE for wireless communication is described. The NE may be configured to, capable of, or operable to configure a CSI-RS resource comprising a plurality of CSI-RS ports grouped into one or more CDM groups, generate, for the CSI-RS resource, a configuration message comprising one or more indicators defining a partial RE mapping in a time domain or a frequency domain, wherein the partial RE mapping specifies a quantity of REs for the at least one CDM group, wherein the quantity of REs is less than a quantity of CSI-RS ports of the at least one CDM group, and transmit the configuration message to a UE to enable the UE to receive and measure the CSI-RS according to the partial RE mapping.

A processor for wireless communication is described. The processor may be configured to, capable of, or operable to configure a CSI-RS resource comprising a plurality of CSI-RS ports grouped into one or more CDM groups, generate, for the CSI-RS resource, a configuration message comprising one or more indicators defining a partial RE mapping in a time domain or a frequency domain, wherein the partial RE mapping specifies a quantity of REs for the at least one CDM group, wherein the quantity of REs is less than a quantity of CSI-RS ports of the at least one CDM group, and transmit the configuration message to a UE to enable the UE to receive and measure the CSI-RS according to the partial RE mapping.

A method for wireless communication performed by a NE is described. The method may be configured to, capable of, or operable to configure a CSI-RS resource comprising a plurality of CSI-RS ports grouped into one or more CDM groups, generate, for the CSI-RS resource, a configuration message comprising one or more indicators defining a partial RE mapping in a time domain or a frequency domain, wherein the partial RE mapping specifies a quantity of REs for the at least one CDM group, wherein the quantity of REs is less than a quantity of CSI-RS ports of the at least one CDM group, and transmit the configuration message to a UE to enable the UE to receive and measure the CSI-RS according to the partial RE mapping.

### BRIEF DESCRIPTION OF THE DRAWINGS

FIG. 1 illustrates an example of a wireless communications system in accordance with aspects of the present disclosure.

FIG. 2 depicts one example of a CSI-RS configuration table in accordance with aspects of the present disclosure.

FIG. 3 depicts one example of a CSI-RS configuration table in accordance with aspects of the present disclosure.

FIG. 4 illustrates an example representation of a configuration with two CSI-RS resources in accordance with aspects of the present disclosure.

FIG. 5 illustrates an example of a UE in accordance with aspects of the present disclosure.

FIG. 6 illustrates an example of a processor in accordance with aspects of the present disclosure.

FIG. 7 illustrates an example of an NE in accordance with aspects of the present disclosure.

FIG. 8 illustrates a flowchart of a method performed by a UE in accordance with aspects of the present disclosure.

FIG. 9 illustrates a flowchart of a method performed by an NE in accordance with aspects of the present disclosure.

### DETAILED DESCRIPTION

In wireless communication systems such as 5G New Radio (NR) and future 6G systems, CSI-RS are used by UE to measure downlink channel conditions and report CSI to a serving NE. CSI-RS resources include multiple antenna ports that are grouped into CDM groups, with each CDM group mapped to a defined number or quantity of REs in the time and frequency domains. In existing NR specifications, the number of REs allocated to each CDM group is equal to the number of CSI-RS ports associated with that CDM group. This “full RE mapping” ensures orthogonality of the CSI-RS sequences but causes CSI-RS overhead to scale linearly with the number of antenna ports.

As the industry advances toward very large antenna-array systems for 6G, CSI-RS port counts of 64, 128, or more are anticipated. With such high port counts, the number of REs required for CSI-RS transmission can consume a substantial portion of the available resources within a slot, significantly reducing the resources available for data transmission. In some cases, CSI-RS overhead can dominate an entire physical resource block (PRB) or slot, undermining the benefits of large-scale MIMO operation. Increasing CSI-RS density in the frequency domain can further exacerbate this overhead. As a result, relying solely on the full RE mapping approach specified in current NR releases becomes increasingly impractical for next-generation systems.

The techniques described herein address these challenges by introducing partial CSI-RS RE mapping. In the disclosed approach, the NE determines a quantity of REs for at least one CDM group that is less than the number of CSI-RS ports associated with that group. The NE then signals this partial RE mapping to the UE via one or more indicators, enabling CSI-RS transmission using fewer REs while still supporting channel estimation. By reducing the RE count per CDM group, CSI-RS overhead can be substantially lowered without requiring changes to the number of antenna ports supported. The disclosed techniques can be implemented through new CSI-RS configuration rows, override signaling of time-domain or frequency-domain index sets, codepoint mapping, or hybrid scheduling of full-RE and partial-RE mapped CSI-RS resources.

These techniques allow NE to reduce reference-signal overhead while maintaining acceptable channel-estimation performance, particularly when advanced estimation algorithms—such as compressed sensing or sparsity-aware estimation—are employed. As a result, partial RE mapping provides a scalable framework for high-port-count MIMO operation in 6G and beyond, enabling more efficient use of time-frequency resources and improved system spectral efficiency.

Aspects of the present disclosure are described in the context of a wireless communications system. Note that one or more aspects from different solutions may be combined.

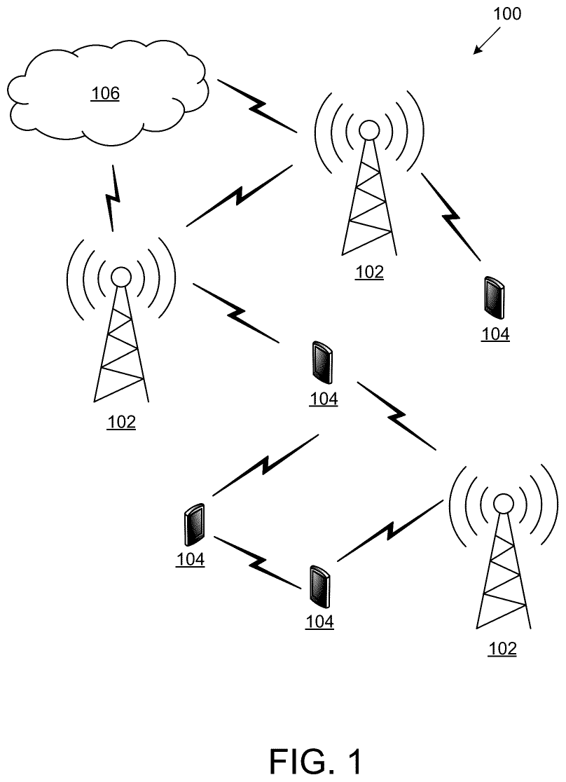

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as a Long-Term Evolution (LTE) network or an LTE-Advanced (LTE-A) network. In some other implementations, the wireless communications system 100 may be a New Radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or a PDN connection, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., orthogonal frequency-division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHZ-52.6 GHZ), FR3 (7.125 GHz-24.25 GHZ), FR4 (52.6 GHz-114.25 GHZ), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In the wireless communications system 100 illustrated in FIG. 1, the one or more NE 102 may further be configured to transmit CSI-RS to one or more UEs 104 for purposes of channel and/or interference measurements and CSI reporting. As described herein, conventional CSI-RS configurations allocate, for each CDM group of CSI-RS ports, a quantity of REs equal to the number of ports in that CDM group, resulting in CSI-RS overhead that increases linearly with the total number of ports supported by the NE 102. In accordance with aspects of the present disclosure, the NE 102 may instead determine and signal to the UE 104 a partial CSI-RS RE mapping, in which fewer REs than CSI-RS ports are allocated for at least one CDM group.

For example, the NE 102 may generate a configuration message comprising one or more indicators—such as modified time-domain or frequency-domain index sets, codepoints, or other mapping parameters—that define a reduced set of REs for CSI-RS transmission. Upon receiving the configuration message, the UE 104 may receive and measure the CSI-RS based on the partial RE mapping, enabling channel estimation while reducing CSI-RS overhead in the time-frequency resources of system 100. The techniques described herein may be applied across any of the radio access technologies or numerologies supported in wireless communications system 100 and are particularly beneficial for high-port-count MIMO configurations anticipated in 5G-Advanced and 6G systems.

In one example, CSI-RS resource configurations and specifications are defined in various third generation partnership project (3GPP) technical specifications, including 3GPP technical specification (TS) 38.211, 3GPP TS 38.214, and 3GPP TS 38.331 (all incorporated herein by reference). In NR, CSI-RS resources may be configured for a UE to enable interference and CSI estimation, which may be used for, for example, beamforming, link adaptation, and other advanced multi-antenna techniques.

According to 3GPP TS 38.214, clause 5.2.2.3, a UE may be configured with one or more non-zero-power (NZP) CSI-RS resource set configurations via higher-layer parameters such as CSI-ResourceConfig and NZP-CSI-RS-ResourceSet. Each NZP CSI-RS resource set may include one or more NZP CSI-RS resources. For each CSI-RS resource configuration, a variety of parameters may be signaled to the UE, based on which the UE may assume non-zero transmission power for the CSI-RS. These parameters may include a CSI-RS resource identity (nzp-CSI-RS-ResourceId) and a periodicity and slot offset (periodicity AndOffset) that define the periodic or semi-persistent transmission occasions for the CSI-RS. In some examples, all CSI-RS resources within a set share a common periodicity, although the slot offset may be the same or different among the resources.

The configuration may also include a resource-mapping parameter (resourceMapping) that defines characteristics such as the number of CSI-RS ports, the applicable CDM type, and the OFDM symbol and subcarrier occupancy of the CSI-RS resource within a slot. The allowed values for these parameters may be provided in clause 7.4.1.5 of TS 38.211. A related parameter (nrofPorts) may indicate the number of CSI-RS ports, while a density parameter (density) may define the CSI-RS frequency density per physical resource block (PRB), and when applicable, a PRB offset, for example when the density value is ½. For such cases, odd/even PRB allocation may be specified relative to the common resource-block grid.

Additional parameters may include the CDM pattern (cdm-Type), which may specify CDM types such as noCDM, fd-CDM2, or CDM patterns involving multiple time/frequency dimensions. Power-control-related parameters may further be provided, including a powerControlOffset that may specify a ratio of physical downlink shared channel (PDSCH) energy per resource element (EPRE) to NZP CSI-RS EPRE used for CSI derivation, and a powerControlOffsetSS that may specify a ratio of NZP CSI-RS EPRE to synchronization signal (SS)/physical broadcast channel (PBCH) EPRE. The configuration may also include a scrambling identifier (scramblingID) for CSI-RS sequence generation and a bandwidth-part identifier (BWP-Id) specifying the BWP within which the CSI-RS is located.

A repetition parameter (repetition) associated with an NZP CSI-RS resource set may indicate whether the UE can assume that CSI-RS resources in the set are transmitted using the same downlink spatial-domain transmission filter, depending on certain reporting configurations. The configuration may further include quasi-co-location (QCL) information (qcl-InfoPeriodicCSI-RS) referencing a transmission configuration indication (TCI) state that identifies QCL source reference signals and QCL types. The referenced RS may be, for example, an SS/PBCH block or another CSI-RS resource located in the same or a different carrier or bandwidth part. Tracking-reference-signal information (trs-Info) may also be associated with a resource set and may allow the UE to assume that antenna ports with the same index across configured NZP CSI-RS resources correspond to the same physical antenna configuration under certain conditions.

In general, for an NZP CSI-RS resource set used for channel measurement, CSI-RS resources within the set are typically configured with the same density and the same number of ports, although certain exceptions may apply, such as for interference-measurement resources or when density ½ is used with specific reporting and codebook types. A UE may additionally expect that all CSI-RS resources in a resource set share a common starting RB, a common number of RBs, and a common CDM type. For CSI-RS sets linked to specific CSI-ReportConfig instances, the UE may further expect consistent QCL information, power-control offsets, and related parameters across all resources in the set.

In some examples, slot offsets between CSI-RS resources within a resource set for channel measurement may be constrained to a limited number of slots, such as within one or two slots, without any downlink/uplink switching between the respective CSI-RS transmissions. Such constraints may be defined in the standard for certain reporting configurations and codebook types.

In one example, e.g., according to 3GPP TS 38.211, clause 7.4.1.5, the bandwidth and initial common resource block (CRB) index of a CSI-RS resource in a bandwidth part (BWP) may be determined based on higher-layer parameters such as nrofRBs and startingRB within a CSI-FrequencyOccupation information element (IE). Both nrofRBs and startingRB may be configured as integer multiples of 4 RBs, with the reference point for startingRB being CRB 0 on the common resource block grid. Based on the relative position of startingRB to the BWP start index and the configured BWP size, the UE may derive the initial CRB index and the effective CSI-RS bandwidth. In general, the resulting CSI-RS bandwidth is constrained by the BWP size, and a minimum CSI-RS bandwidth (e.g., at least a certain number of RBs) may be assumed.

In one example, e.g., according to 3GPP TS 38.211, clause 7.4.1.5, ZP CSI-RS and NZP CSI-RS are distinguishable. For NZP CSI-RS, the sequence is generated according to a sequence generation clause (e.g., clause 7.4.1.5.2) and mapped to resource elements according to a resource mapping clause (e.g., clause 7.4.1.5.3). For ZP CSI-RS, the UE generally assumes that the specified resource elements are reserved (e.g., not used for PDSCH), but the UE may still perform reception and measurement on other channels or signals that overlap ZP CSI-RS REs.

In one example, a pseudo-random sequence generator may be initialized based on parameters such as a slot index within a radio frame, an OFDM symbol index within the slot, and a scrambling identifier (e.g., scramblingID or sequenceGenerationConfig). The resulting sequence may then be mapped to CSI-RS REs within one or more RBs and symbols according to parameters including density (ρ), the number of ports per resource (N), and a port mapping method.

The total number of CSI-RS ports for a configured CSI-RS resource or set of resources may be denoted by N_tot. For certain values (for example, N_tot in {1, 2, 4, 8, 12, 16, 24, 32}), a single CSI-RS resource with N ports may be configured. For larger values (for example, N_tot in {48, 64, 128}), a CSI-RS resource may be formed by aggregating K CSI-RS resources, each with N ports, such that N_tot=K·N. The possible combinations of N_tot, K, and N may be specified in a table such as Table 7.4.1.5.3-6 of TS 38.211. In such cases, a resource index q may identify the position of each CSI-RS resource within the aggregated CSI-RS resource.

The mapping of CSI-RS sequences to REs is further characterized by CDM groups. For each row of a CSI-RS configuration table (e.g., Table 7.4.1.5.3-1), the CDM group size (e.g., 1, 2, 4, or 8), the time-domain anchor symbol locations (e.g., 10, 11), and the frequency-domain offsets (e.g., k0, k1, . . . ) may be defined. A CDM type (e.g., noCDM, fd-CDM2, cdm4-FD2-TD2, cdm8-FD2-TD4) determines the underlying orthogonal sequences applied in time and/or frequency to distinguish ports within a CDM group. Corresponding sequence values may be specified, for example, in tables such as Table 7.4.1.5.3-2 through Table 7.4.1.5.3-5.

TABLE 7.4.1.5.3-1
CSI-RS locations within a slot

| | Ports | Density | | | CDM group | | |
|---|---|---|---|---|---|---|---|
| Row | N | ρ | cdm-Type | (k̅_{q}, l̅_{q}) | index j | k_{q}′ | l_{q}′ |
| 1 | 1 | 3 | noCDM | (k₀, l₀), (k₀ + 4, l₀), | 0, 0, 0 | 0 | 0 |
| | | | | (k₀ + 8, l₀) | | | |
| 2 | 1 | 1, 0.5 | noCDM | (k₀, l₀), | 0 | 0 | 0 |
| 3 | 2 | 1, 0.5 | fd-CDM2 | (k₀, l₀), | 0 | 0, 1 | 0 |
| 4 | 4 | 1 | fd-CDM2 | (k₀, l₀), (k₀ + 2, l₀) | 0, 1 | 0, 1 | 0 |
| 5 | 4 | 1 | fd-CDM2 | (k₀, l₀), (k₀, l₀ + 1) | 0, 1 | 0, 1 | 0 |
| 6 | 8 | 1 | fd-CDM2 | (k₀, l₀), (k₁, l₀), (k₂, l₀), | 0, 1, 2, 3 | 0, 1 | 0 |
| | | | | (k₃, l₀) | | | |
| 7 | 8 | 1 | fd-CDM2 | (k₀, l₀), (k₁, l₀), (k₀, l₀ + | 0, 1, 2, 3 | 0, 1 | 0 |
| | | | | 1), (k₁, l₀ + 1) | | | |
| 8 | 8 | 1 | cdm4-FD2- | (k₀, l₀), (k₁, l₀) | 0, 1 | 0, 1 | 0, 1 |
| | | | TD2 | | | | |
| 9 | 12 | 1 | fd-CDM2 | (k₀, l₀), (k₁, l₀), (k₂, l₀), | 0, 1, 2, 3, 4, 5 | 0, 1 | 0 |
| | | | | (k₃, l₀), (k₄, l₀), (k₅, l₀) | | | |
| 10 | 12 | 1 | cdm4-FD2- | (k₀, l₀), (k₁, l₀), (k₂, l₀) | 0, 1, 2 | 0, 1 | 0, 1 |
| | | | TD2 | | | | |
| 11 | 16 | 1, 0.5 | fd-CDM2 | (k₀, l₀), (k₁, l₀), (k₂, l₀), | 0, 1, 2, 3, | 0, 1 | 0 |
| | | | | (k₃, l₀), (k₀, l₀ + 1), | 4, 5, 6, 7 | | |
| | | | | (k₁, l₀ + 1), (k₂, l₀ + 1), | | | |
| | | | | (k₃, l₀ + 1) | | | |
| 12 | 16 | 1, 0.5 | cdm4-FD2- | (k₀, l₀), (k₁, l₀), (k₂, l₀), | 0, 1, 2, 3 | 0, 1 | 0, 1 |
| | | | TD2 | (k₃, l₀) | | | |
| 13 | 24 | 1, 0.5 | fd-CDM2 | (k₀, l₀), (k₁, l₀), (k₂, l₀), | 0, 1, 2, 3, 4, 5, | 0, 1 | 0 |
| | | | | (k₀, l₀ + 1), (k₁, l₀ + 1), | 6, 7, 8, 9, 10, 11 | | |
| | | | | (k₂, l₀ + 1), (k₀, l₁), | | | |
| | | | | (k₁, l₁), (k₂, l₁), (k₀, l₁ + | | | |
| | | | | 1), (k₁, l₁ + 1), (k₂, l₁ + | | | |
| | | | | 1) | | | |
| 14 | 24 | 1, 0.5 | cdm4-FD2- | (k₀, l₀), (k₁, l₀), (k₂, l₀), | 0, 1, 2, 3, 4, 5 | 0, 1 | 0, 1 |
| | | | TD2 | (k₀, l₁), (k₁, l₁), (k₂, l₁) | | | |
| 15 | 24 | 1, 0.5 | cdm8-FD2- | (k₀, l₀), (k₁, l₀), (k₂, l₀) | 0, 1, 2 | 0, 1 | 0, 1, |
| | | | TD4 | | | | 2, 3 |
| 16 | 32 | 1, 0.5 | fd-CDM2 | (k₀, l₀), (k₁, l₀), (k₂, l₀), | 0, 1, 2, 3, | 0, 1 | 0 |
| | | | | (k₃, l₀), (k₀, l₀ + 1), | 4, 5, 6, 7, | | |
| | | | | (k₁, l₀ + 1), (k₂, l₀ + 1), | 8, 9, 10, 11, | | |
| | | | | (k₃, l₀ + 1), (k₀, l₁), | 12, 13, 14, 15 | | |
| | | | | (k₁, l₁), (k₂, l₁), (k₃, l₁), | | | |
| | | | | (k₀, l₁ + 1), (k₁, l₁ + 1), | | | |
| | | | | (k₂, l₁ + 1), (k₃, l₁ + 1) | | | |
| 17 | 32 | 1, 0.5 | cdm4-FD2- | (k₀, l₀), (k₁, l₀), (k₂, l₀), | 0, 1, 2, 3, 4, 5, 6, 7 | 0, 1 | 0, 1 |
| | | | TD2 | (k₃, l₀), (k₀, l₁), (k₁, l₁), | | | |
| | | | | (k₂, l₁), (k₃, l₁) | | | |
| 18 | 32 | 1, 0.5 | cdm8-FD2- | (k₀, l₀), (k₁, l₀), (k₂, l₀), | 0, 1, 2, 3 | 0, 1 | 0, 1, |
| | | | TD4 | (k₃, l₀) | | | 2, 3 |

TABLE 7.4.1.5.3-2
The sequences w_{f}(k_{q}^{′}) and wₜ(l_{q}^{′}) for cdm-Type equal to ‘noCDM’

| Index | w_{f}(0) | wₜ(0) |
|---|---|---|
| 0 | 1 | 1 |

TABLE 7.4.1.5.3-3
The sequences w_{f}(k_{q}^{′}) and wₜ(l_{q}^{′}) for cdm-Type equal to ‘fd-CDM2’

| Index | [w_{f}(0) w_{f}(1)] | wₜ(0) |
|---|---|---|
| 0 | [+1 +1] | 1 |
| 1 | [+1 −1] | 1 |

TABLE 7.4.1.5.3-4
The sequences w_{f}(k_{q}^{′}) and wₜ(l_{q}^{′})
for cdm-Type equal to ‘cdm4-FD2-TD2’

| Index | [w_{f}(0) w_{f}(1)] | [wₜ(0) wₜ(1)] |
|---|---|---|
| 0 | [+1 +1] | [+1 +1] |
| 1 | [+1 −1] | [+1 +1] |
| 2 | [+1 +1] | [+1 −1] |
| 3 | [+1 −1] | [+1 −1] |

TABLE 7.4.1.5.3-5
The sequences w_{f}(k_{q}^{′}) and wₜ(l_{q}^{′})
for cdm-Type equal to ‘cdm8-FD2-TD4’

| Index | [w_{f}(0) w_{f}(1)] | [wₜ(0) wₜ(1) wₜ(2) wₜ(3)] |
|---|---|---|
| 0 | [+1 +1] | [+1 +1 +1 +1] |
| 1 | [+1 −1] | [+1 +1 +1 +1] |
| 2 | [+1 +1] | [+1 −1 +1 −1] |
| 3 | [+1 −1] | [+1 −1 +1 −1] |
| 4 | [+1 +1] | [+1 +1 −1 −1] |
| 5 | [+1 −1] | [+1 +1 −1 −1] |
| 6 | [+1 +1] | [+1 −1 −1 +1] |
| 7 | [+1 −1] | [+1 −1 −1 +1] |

TABLE 7.4.1.5.3-6
The supported combinations of Nₜₒₜ, K, and N when
the number of CSI-RS ports is 48, 64, or 128

| Nₜₒₜ | K | N |
|---|---|---|
| 48 | 2 | 24 |
| 48 | 3 | 16 |
| 64 | 4 | 16 |
| 64 | 2 | 32 |
| 128 | 4 | 32 |

In some examples, the time-domain locations (e.g., first and second OFDM symbols for CSI-RS within a slot) are provided via higher-layer parameters such as firstOFDMSymbolInTimeDomain and firstOFDMSymbolInTimeDomain2. Frequency-domain locations may be derived from a frequency-domain allocation bitmap, as provided by higher-layer parameters such as frequencyDomainAllocation, together with the configured density and bandwidth.

The CSI-RS ports used to transmit a CSI-RS resource may be numbered according to a base offset and a port index, where the specific mapping may depend on whether the total number of ports corresponds to a single resource or an aggregated resource, and may further depend on a port mapping method (e.g., a first or second method defined in the standard). Within a given row of a CSI-RS configuration table, a CDM group index may correspond to specific time/frequency positions, and the CDM groups may be ordered first in frequency and then in time.

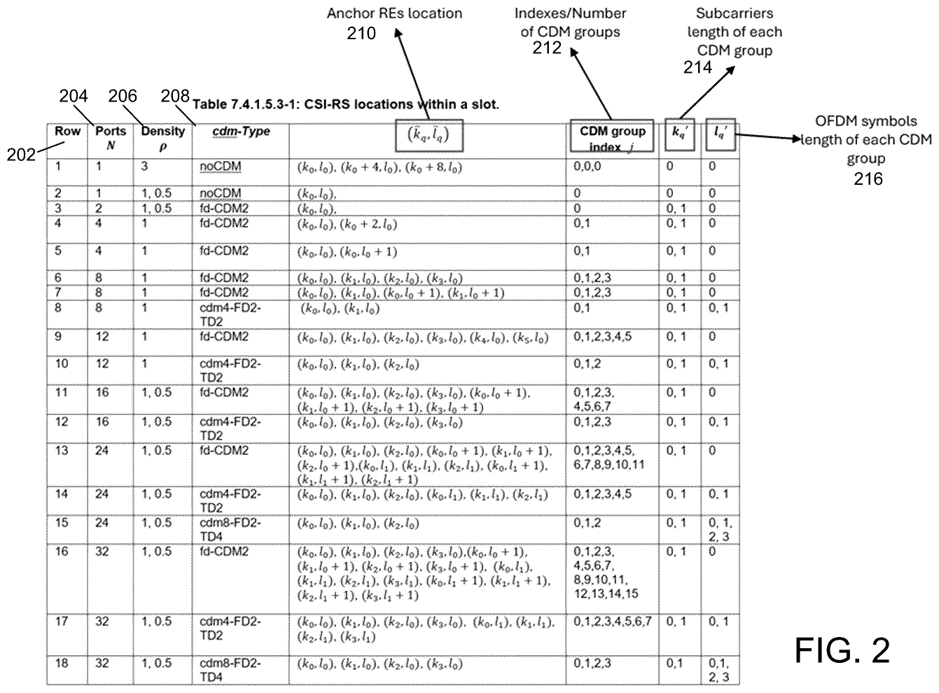

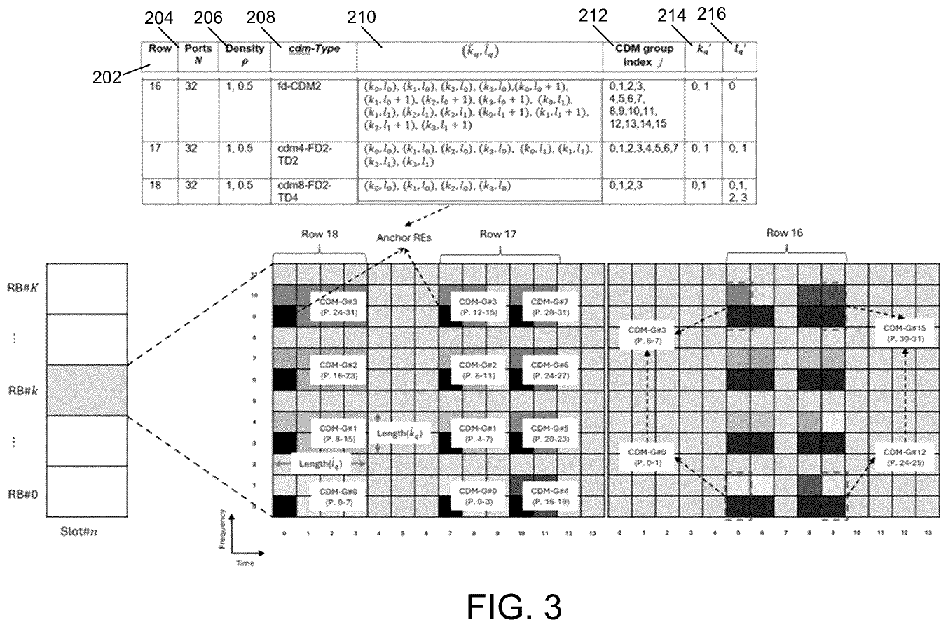

For instance, table 7.4.1.5.3-1 in TS 38.211, shown in FIG. 2, provides example CSI-RS configurations within a slot, including, for each row 202, the number of ports N 204, allowable density values 206, the CDM type 208, a set of time/frequency anchor locations 210 for each CDM group, indexes/number of CDM groups 212, subcarriers length of each CDM group 214, and OFDM symbols length of each CDM group 216. For rows associated with 32 ports (for example, rows 16-18), shown in FIG. 3, different time/frequency patterns may be provided, resulting in different distributions of REs among CDM groups. Among the information provided by Table 7.4.1.5.3-1, the last four columns provide information to determine the REs within an RB (and a slot) wherein CSI-RS is mapped and transmitted. FIG. 3 shows a possible CSI-RS to RE mapping on an RB for Rows 16, 17, and 18.

In one example, CSI-RS ports may be partitioned into L CDM groups, each with N/L ports. For each CDM group, a corresponding set of REs may be defined by an anchor location, a frequency span, and a time span, such that the number of REs per CDM group equals the number of ports per CDM group. In such configurations, the overall RE usage within an RB and slot increases roughly linearly with the number of CSI-RS ports.

The density parameter may control the distribution of CSI-RS across RBs. For instance, a density of 1 may imply CSI-RS mapping on every RB within a configured set of RBs, while a density of ½ may imply mapping on every other RB. As a result, the fraction of total REs in a slot occupied by CSI-RS may scale with both the number of ports and the density. Reducing density (e.g., from 1 to ½ or lower) may reduce CSI-RS overhead proportionally.

Assuming ideal cyclic prefix (CP)-OFDM modulation and, for example, that the channel coefficients across the REs of a given CDM group are approximately constant, the received measurements for that CDM group may be expressed as Y=H X+Z, where H is a frequency-domain channel matrix of dimension R×N_Ports (with R denoting the number of receive antennas), X is the metricized CSI-RS sequence matrix, and Z represents additive noise and, where applicable, interference. With the structure of X, an estimate of the MIMO channel matrix H may be obtained using a least-squares (LS) estimator, for example Ĥ=(1/N_Ports)·Y X^{H}. More advanced channel-estimation techniques—such as compressed-sensing-based methods or other sparsity-aware algorithms—may achieve comparable or improved CSI estimation accuracy using fewer measurements, i.e., using a reduced number of REs. The effectiveness of such techniques may depend on channel characteristics such as rank or sparsity, which in turn can vary based on carrier frequency, propagation environment, or deployment scenario. Accordingly, the present disclosure provides enhancements to CSI-RS configuration mechanisms that enable an adaptive number of REs to be allocated per CDM group.

In accordance with a first example, the NE or the UE may extend the CSI-RS location configurations defined in Table 7.4.1.5.3-1 of 3GPP TS 38.211 to include one or more additional row indices that explicitly support partial RE mapping. As used herein, partial RE mapping refers to a mapping configuration in which the number or quantity of REs allocated to a particular CDM group is less than the number of CSI-RS ports associated with that CDM group. This contrasts with full RE mapping—as specified in existing NR releases—where the number of REs assigned to each CDM group is equal to the number of ports in that group.

Under the proposed extension, the NE may configured the UE with one or more CSI-RS resources that correspond to newly added row indices, each defining a reduced set of RE positions in the time and/or frequency domain for at least one CDM group. For such a resource, the UE receives a CSI-RS resource configuration indicating the new row index and interprets the accompanying time-domain and frequency-domain index sets (e.g., k′ₚ and l′ₚ) as defining fewer REs than would be allocated under the nearest existing configuration in Table 7.4.1.5.3-1.

Several illustrative examples of new row indices are provided in Table 1. Each example is derived from the structure of existing Row 18, which corresponds to a CSI-RS resource with 32 ports, four CDM groups, and a cdm8-FD2-TD4 CDM type. In a first example (Row 19-1), the values of k′ₚ are preserved from Row 18, but the time-domain index set l′ₚ is shortened; for instance, the set {0, 1, 2, 3} may be reduced to {0, 1, 2}, thereby reducing the number of REs associated with each CDM group. In a second example (Row 19-2), both the l′ₚ set and the CDM type are modified. For instance, the CDM type may be changed from cdm8-FD2-TD4 to cdm6-FD2-TD3 to correspond to the reduced number of REs. Such a CDM type may be derived from the larger cdm8-FD2-TD4 sequence by omitting one or more time-domain sequences, as illustrated in Table 2. In a third example (Row 19-3), the CDM type may be reduced further (e.g., cdm4-FD2-TD2), enabling the NE to support even smaller RE allocations while maintaining the orthogonality structure expected by the UE.

In some examples, a newly added row may rely on a CDM sequence derived from an existing sequence through truncation or omission of specific time-domain or frequency-domain sequence components. In other implementations, a new or modified CDM sequence may be introduced specifically for partial RE mapping configurations. The NE may select which row to use based on various factors, including the number of CSI-RS ports, channel sparsity characteristics, UE capability feedback, or expected channel-estimation performance under reduced-measurement conditions.

By extending the CSI-RS configuration table in this manner, the NE gains the flexibility to allocate fewer REs to CSI-RS resources-thereby reducing reference-signal overhead-without fundamentally altering the port structure or CDM-grouping rules defined in existing NR standards.

TABLE 1
New Rows added to Table 7.4.1.5.3-1 of TS38.211

| | | | | | CDM | | |
|---|---|---|---|---|---|---|---|
| | Ports | Density | | | group | | |
| Row | N | ρ | cdm-Type | (k̅_{q}, l̅_{q}) | index j | \acute{k}_{q} | ĺ_{q} |
| . . . | . . . | . . . | . . . | . . . | . . . | . . . | . . . |
| 18 | 32 | 1, ½ | cdm8-FD2- | (k₀, l₀), (k₁, l₀), (k₂, l₀), (k₃, l₀) | 0, 1, 2, 3 | 0, 1 | 0, 1, 2, 3 |
| | | | TD4 | | | | |
| 19-1 | 32 | 1, ½ | cdm8-FD2- | (k₀, l₀), (k₁, l₀), (k₂, l₀), (k₃, l₀) | 0, 1, 2, 3 | 0, 1 | 0, 1, 2 |
| | | | TD4 | | | | |
| 19-2 | 32 | 1, ½ | cdm6-FD2- | (k₀, l₀), (k₁, l₀), (k₂, l₀), (k₃, l₀) | 0, 1, 2, 3 | 0, 1 | 0, 1, 2 |
| | | | TD3 | | | | |
| 19-3 | 32 | 1, ½ | cdm4-FD2- | (k₀, l₀), (k₁, l₀), (k₂, l₀), (k₃, l₀) | 0, 1, 2, 3 | 0, 1 | 0, 1 |
| | | | TD2 | | | | |

TABLE 2
Sequences w_{f}(\acute{k}_{q}) and w_{f}(ĺ_{q}) for
cdm-Type cdm6-FD2-TD3 and cdm4-FD2-TD2

| | |
|---|---|
| cdm6-FD2-TD3 | cdm4-FD2-TD2 |

| | [w_{f}(0) | [wₜ(0) wₜ(1) | | [w_{f}(0) | [wₜ(0) |
|---|---|---|---|---|---|
| index | w_{f}(1)] | wₜ(2)] | index | w_{f}(1)] | wₜ(1)] |
| 0 | [+1 +1] | [+1 +1 +1] | 0 | [+1 +1] | [+1 +1] |
| 1 | [+1 −1] | [+1 +1 +1] | 1 | [+1 −1] | [+1 +1] |
| 2 | [+1 +1] | [+1 −1 +1] | 2 | [+1 +1] | [+1 −1] |
| 3 | [+1 −1] | [+1 −1 +1] | 3 | [+1 −1] | [+1 −1] |
| 4 | [+1 +1] | [+1 +1 −1] | 4 | [+1 +1] | [+1 +1] |
| 5 | [+1 −1] | [+1 +1 −1] | 5 | [+1 −1] | [+1 +1] |
| 6 | [+1 +1] | [+1 −1 −1] | 6 | [+1 +1] | [+1 −1] |
| 7 | [+1 −1] | [+1 −1 −1] | 7 | [+1 −1] | [+1 −1] |

In accordance with another example, the CSI-RS location configurations defined in Table 7.4.1.5.3-1 of 3GPP TS 38.211 may be preserved in their existing form, while additional signaling is introduced to allow a NE to override the default time-domain and frequency-domain index sets for RE mapping. Under this approach, a UE may receive, through one or more higher-layer or lower-layer signaling mechanisms—such as a radio resource control (RRC) message, a medium-access-control control element (MAC-CE), or downlink control information (DCI)—explicit values for k′ and/or l′ that define a modified RE mapping for at least one CDM group. These explicitly signaled values may replace or reconfigure the default index sets associated with the corresponding row index of Table 7.4.1.5.3-1, thereby enabling partial RE mapping without the need to modify the underlying table structure.

In some examples, updating the k′ and/or l′ sets may implicitly modify the CDM type associated with the CSI-RS resource. For example, if the number of REs specified by the overridden k′ or l′ values is smaller than the number associated with the default CDM type, the UE may interpret the signaling as instructing the omission of one or more time-domain or frequency-domain sequence components. In other implementations, the NE may explicitly specify a different CDM type to correspond to the reduced RE mapping. The NE may use modified CDM types—such as truncated versions of existing sequences or newly defined sequences—to maintain orthogonality among CSI-RS ports even when fewer REs are used.

In some examples, the NE may convey the overridden k′ and l′ values compactly through a codepoint mapping. Under such an arrangement, the NE may transmit a codepoint index that the UE maps to predetermined k′ and l′ sets. For instance, a codepoint of “0” may correspond to k′={0} and l′={0}, a codepoint of “1” may correspond to k′={0, 1} and l′={0}, a codepoint of “2” may correspond to k′={0, 1} and l′={0, 1}, and so on. This approach reduces signaling overhead while enabling flexible partial RE mapping configurations.

In another aspect of this example, the NE may combine adjustments to RE density (within a CDM group) with adjustments to RB-level density in the frequency domain. For example, during certain transmission occasions, the NE or the UE may apply full RE mapping using the default table values, while during other transmission occasions partial RE mapping may be applied using overridden k′ or l′ values. In this manner, RE density in the time domain may vary slot-by-slot or symbol-by-symbol, complementing RB-level density defined in the frequency domain.

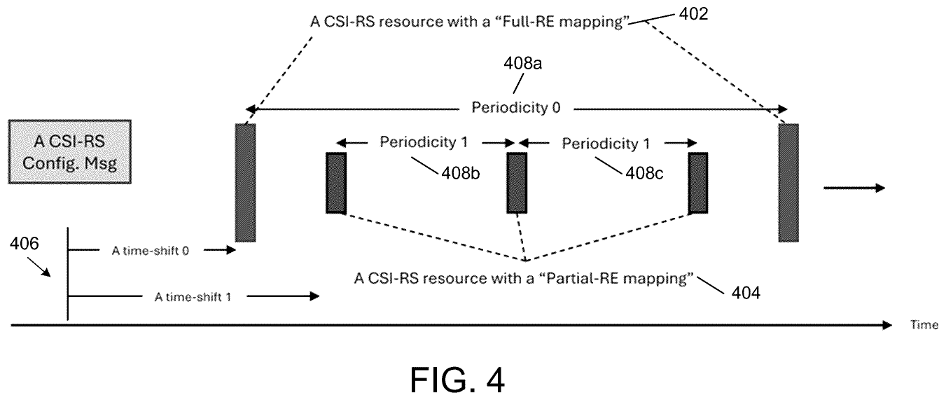

According to one implementation, an NE may configure a UE with two CSI-RS resources 402, 404—one associated with full RE mapping and another associated with partial RE mapping, as conceptually illustrated in FIG. 4. Each CSI-RS resource 402, 404 may be independently configured and may include distinct parameters such as row index, periodicity, offset, start time, CDM type, or density. In some examples, the two CSI-RS resources 402, 404 may share one or more common parameters (e.g., the same row index), while differing in one or more other parameters that distinguish full versus partial mapping behavior.

In certain configurations, the NE may provide the respective time shifts 406 or periodicity indicators 408a-c for the two CSI-RS resources 402, 404 relative to the receipt of a triggering message. In other configurations, the NE may signal a relative time shift 406 between the two CSI-RS resources 402, 404 themselves. In the event that the transmission occasions of the two CSI-RS resources 402, 404 overlap or collide—such as when periodicities 408a-c and offsets align—the UE may apply a predetermined collision-resolution rule. Such a rule may specify, for example, that the CSI-RS resource 402, 404 with the shorter periodicity 408a-c is cancelled in favor of the CSI-RS resource 402, 404 with the longer periodicity 408a-c, or vice versa. In some implementations, the NE may cancel both CSI-RS resources 402, 404 for that occasion. These rules ensure predictable UE behavior when full-RE and partial-RE CSI-RS mapping configurations coexist.

Through this signaling-based approach, the NE gains significant flexibility to dynamically adapt CSI-RS RE usage without altering the underlying specification-defined table entries, and without requiring changes to the number of CSI-RS ports or CDM-group structure. This enables efficient overhead reduction while maintaining backward compatibility with existing CSI-RS configuration frameworks.

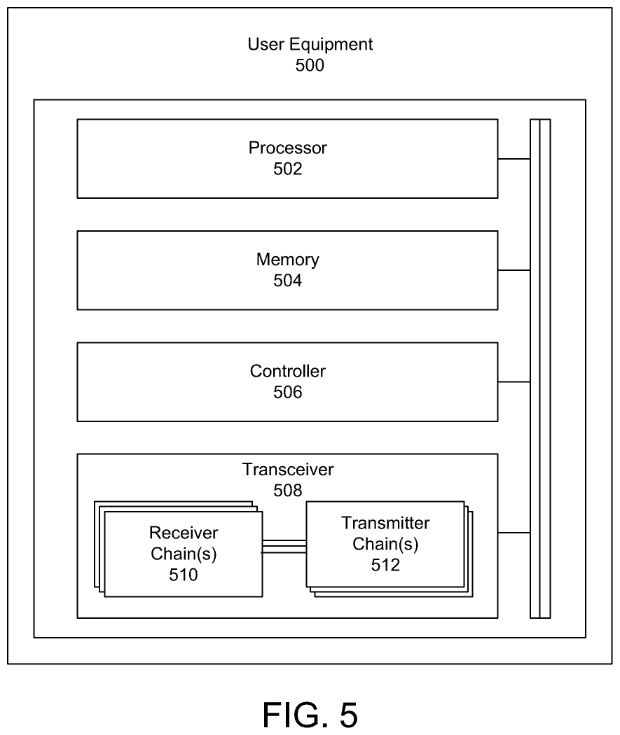

FIG. 5 illustrates an example of a UE 500 in accordance with aspects of the present disclosure. The UE 500 may include a processor 502, a memory 504, a controller 506, and a transceiver 508. The processor 502, the memory 504, the controller 506, or the transceiver 508, or various combinations thereof or various components thereof may be examples of means for performing various aspects of the present disclosure as described herein. These components may be coupled (e.g., operatively, communicatively, functionally, electronically, electrically) via one or more interfaces.

The processor 502, the memory 504, the controller 506, or the transceiver 508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 502 may include an intelligent hardware device (e.g., a general-purpose processor, a DSP, a central processing unit (CPU), an ASIC, a field programmable gate array (FPGA), or any combination thereof). In some implementations, the processor 502 may be configured to operate the memory 504. In some other implementations, the memory 504 may be integrated into the processor 502. The processor 502 may be configured to execute computer-readable instructions stored in the memory 504 to cause the UE 500 to perform various functions of the present disclosure.

The memory 504 may include volatile or non-volatile memory. The memory 504 may store computer-readable, computer-executable code including instructions that, when executed by the processor 502, cause the UE 500 to perform various functions described herein. The code may be stored in a non-transitory computer-readable medium such the memory 504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 502 and the memory 504 coupled with the processor 502 may be configured to cause the UE 500 to perform one or more of the UE functions described herein (e.g., executing, by the processor 502, instructions stored in the memory 504). Accordingly, the processor 502 may support wireless communication at the UE 500 in accordance with examples as disclosed herein.

In one example, a UE 500 is configured to receive a configuration message configuring a CSI-RS resource comprising a plurality of CSI-RS ports grouped into one or more CDM groups, determine, from the configuration message, one or more indicators defining a partial RE mapping in a time domain or a frequency domain, wherein the partial RE mapping specifies a quantity of REs for at least one CDM group of the one or more CDM groups and wherein the quantity of REs is less than a quantity of CSI-RS ports of the at least one CDM group, receive the CSI-RS according to the partial RE mapping, and perform one or more CSI measurements based on the CSI-RS received according to the partial RE mapping.

The controller 506 may manage input and output signals for the UE 500. The controller 506 may also manage peripherals not integrated into the UE 500. In some implementations, the controller 506 may utilize an operating system (OS) such as iOS®, ANDROID®, WINDOWS®, or other operating systems. In some implementations, the controller 506 may be implemented as part of the processor 502.

In some implementations, the UE 500 may include at least one transceiver 508. In some other implementations, the UE 500 may have more than one transceiver 508. The transceiver 508 may represent a wireless transceiver. The transceiver 508 may include one or more receiver chains 510, one or more transmitter chains 512, or a combination thereof.

A receiver chain 510 may be configured to receive signals (e.g., control information, data, packets) over a wireless medium. For example, the receiver chain 510 may include one or more antennas for receiving the signal over the air or wireless medium. The receiver chain 510 may include at least one amplifier (e.g., a low-noise amplifier (LNA)) configured to amplify the received signal. The receiver chain 510 may include at least one demodulator configured to demodulate the received signal and obtain the transmitted data by reversing the modulation technique applied during transmission of the signal. The receiver chain 510 may include at least one decoder for decoding/processing the demodulated signal to receive the transmitted data.

A transmitter chain 512 may be configured to generate and transmit signals (e.g., control information, data, packets). The transmitter chain 512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 512 may also include at least one power amplifier configured to amplify the modulated signal to an appropriate power level suitable for transmission over the wireless medium. The transmitter chain 512 may also include one or more antennas for transmitting the amplified signal into the air or wireless medium.

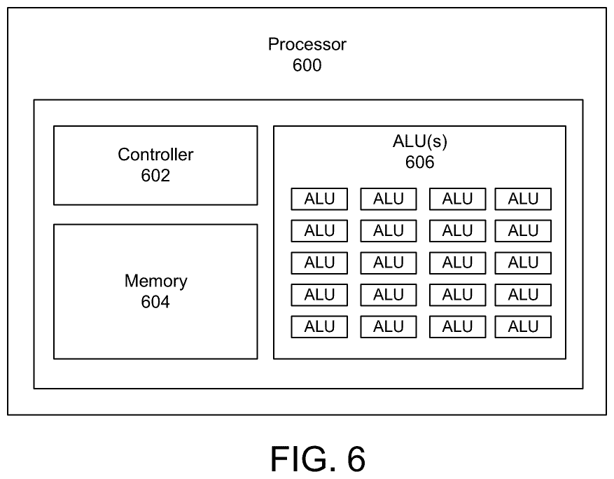

FIG. 6 illustrates an example of a processor 600 in accordance with aspects of the present disclosure. The processor 600 may be an example of a processor configured to perform various operations in accordance with examples as described herein. The processor 600 may include a controller 602 configured to perform various operations in accordance with examples as described herein. The processor 600 may optionally include at least one memory 604, which may be, for example, an L1/L2/L3 cache. Additionally, or alternatively, the processor 600 may optionally include one or more arithmetic-logic units (ALUs) 606. One or more of these components may be in electronic communication or otherwise coupled (e.g., operatively, communicatively, functionally, electronically, electrically) via one or more interfaces (e.g., buses).

The processor 600 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 600) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 602 may be configured to manage and coordinate various operations (e.g., signaling, receiving, obtaining, retrieving, transmitting, outputting, forwarding, storing, determining, identifying, accessing, writing, reading) of the processor 600 to cause the processor 600 to support various operations in accordance with examples as described herein. For example, the controller 602 may operate as a control unit of the processor 600, generating control signals that manage the operation of various components of the processor 600. These control signals include enabling or disabling functional units, selecting data paths, initiating memory access, and coordinating timing of operations.

The controller 602 may be configured to fetch (e.g., obtain, retrieve, receive) instructions from the memory 604 and determine subsequent instruction(s) to be executed to cause the processor 600 to support various operations in accordance with examples as described herein. The controller 602 may be configured to track memory address of instructions associated with the memory 604. The controller 602 may be configured to decode instructions to determine the operation to be performed and the operands involved. For example, the controller 602 may be configured to interpret the instruction and determine control signals to be output to other components of the processor 600 to cause the processor 600 to support various operations in accordance with examples as described herein. Additionally, or alternatively, the controller 602 may be configured to manage flow of data within the processor 600. The controller 602 may be configured to control transfer of data between registers, arithmetic logic units (ALUs), and other functional units of the processor 600.

The memory 604 may include one or more caches (e.g., memory local to or included in the processor 600 or other memory, such RAM, ROM, DRAM, SDRAM, SRAM, MRAM, flash memory, etc. In some implementations, the memory 604 may reside within or on a processor chipset (e.g., local to the processor 600). In some other implementations, the memory 604 may reside external to the processor chipset (e.g., remote to the processor 600).

The memory 604 may store computer-readable, computer-executable code including instructions that, when executed by the processor 600, cause the processor 600 to perform various functions described herein. The code may be stored in a non-transitory computer-readable medium such as system memory or another type of memory. The controller 602 and/or the processor 600 may be configured to execute computer-readable instructions stored in the memory 604 to cause the processor 600 to perform various functions. For example, the processor 600 and/or the controller 602 may be coupled with or to the memory 604, the processor 600, the controller 602, and the memory 604 may be configured to perform various functions described herein. In some examples, the processor 600 may include multiple processors and the memory 604 may include multiple memories. One or more of the multiple processors may be coupled with one or more of the multiple memories, which may, individually or collectively, be configured to perform various functions herein.

The one or more ALUs 606 may be configured to support various operations in accordance with examples as described herein. In some implementations, the one or more ALUs 606 may reside within or on a processor chipset (e.g., the processor 600). In some other implementations, the one or more ALUs 606 may reside external to the processor chipset (e.g., the processor 600). One or more ALUs 606 may perform one or more computations such as addition, subtraction, multiplication, and division on data. For example, one or more ALUs 606 may receive input operands and an operation code, which determines an operation to be executed. One or more ALUs 606 be configured with a variety of logical and arithmetic circuits, including adders, subtractors, shifters, and logic gates, to process and manipulate the data according to the operation. Additionally, or alternatively, the one or more ALUs 606 may support logical operations such as AND, OR, exclusive-OR (XOR), not-OR (NOR), and not-AND (NAND), enabling the one or more ALUs 606 to handle conditional operations, comparisons, and bitwise operations.

In various examples, the processor 600 may support wireless communication of a UE, in accordance with examples as disclosed herein. In other examples, the processor 600 may support wireless communication of a RAN entity, in accordance with examples as disclosed herein.

In one example, the processor 600 is configured to receive a configuration message configuring a CSI-RS resource comprising a plurality of CSI-RS ports grouped into one or more CDM groups, determine, from the configuration message, one or more indicators defining a partial RE mapping in a time domain or a frequency domain, wherein the partial RE mapping specifies a quantity of REs for at least one CDM group of the one or more CDM groups and wherein the quantity of REs is less than a quantity of CSI-RS ports of the at least one CDM group, receive the CSI-RS according to the partial RE mapping, and perform one or more CSI measurements based on the CSI-RS received according to the partial RE mapping.

In one example, the processor 600 is configured to configure a CSI-RS resource comprising a plurality of CSI-RS ports grouped into one or more CDM groups, generate, for the CSI-RS resource, a configuration message comprising one or more indicators defining a partial RE mapping in a time domain or a frequency domain, wherein the partial RE mapping specifies a quantity of REs for the at least one CDM group, wherein the quantity of REs is less than a quantity of CSI-RS ports of the at least one CDM group, and transmit the configuration message to a UE to enable the UE to receive and measure the CSI-RS according to the partial RE mapping.

In one example, the one or more indicators comprise at least one of a modified frequency-domain index set (k′) or a modified time-domain index set (l′) that overrides a default CSI-RS RE mapping. In one example, the one or more indicators comprise a codepoint, and the at least one processor is configured to cause the NE to map the codepoint to respective values of k′ and l′ defining the partial RE mapping.

In one example, the partial RE mapping corresponds to a new CSI-RS row index that is not present in a prior version of a CSI-RS configuration table. In one example, the new CSI-RS row index specifies a quantity of REs per CDM group that is less than a quantity of ports per CDM group of an existing CSI-RS row index.

In one example, determining the quantity of REs comprises selecting a subset of time-domain positions, frequency-domain positions, or both, relative to an anchor RE location of the at least one CDM group. In one example, the processor 600 is configured to select a CDM type for the CSI-RS resource based on the determined quantity of Res.

In one example, selecting the CDM type comprises modifying a predefined CDM sequence by omitting at least one time-domain or frequency-domain sequence index. In one example, the processor 600 is configured to determine the partial RE mapping based on at least one of a UE capability indicating support for partial RE mapping, a channel sparsity level, a mobility state of the UE, or a traffic demand condition.

In one example, the processor 600 is configured to configure the UE with a full-RE-mapping CSI-RS resource in addition to a partial-RE-mapping CSI-RS resource. In one example, the full-RE-mapping CSI-RS resource and the partial-RE-mapping CSI-RS resource are transmitted according to different periodicities.

In one example, the full-RE-mapping CSI-RS resource has a longer or sparser periodicity, and the partial-RE-mapping CSI-RS resource has a shorter or finer periodicity. In one example, the processor 600 is configured to apply the partial RE mapping only for selected slots or selected symbols according to a time-division multiplexing pattern.

In one example, the processor 600 is configured to resolve a collision between the CSI-RS resource and another CSI-RS resource by selecting one of the resources according to a priority based on periodicity, CSI-RS type, or reporting configuration. In one example, the one or more indicators further comprise a CSI-RS density value, and the at least one processor is configured to cause the NE to jointly determine a resource-block density and a CDM-group RE density for the CSI-RS resource.

In one example, the processor 600 is configured to dynamically adapt the partial RE mapping based on CSI measurement feedback received from the UE. In one example, the CSI-RS resource comprises at least 32, 48, 64, 128, or more CSI-RS ports, and the partial RE mapping is applied to support high-port-count multi-antenna transmission in a 6G multiple-input multiple-output (MIMO) system.

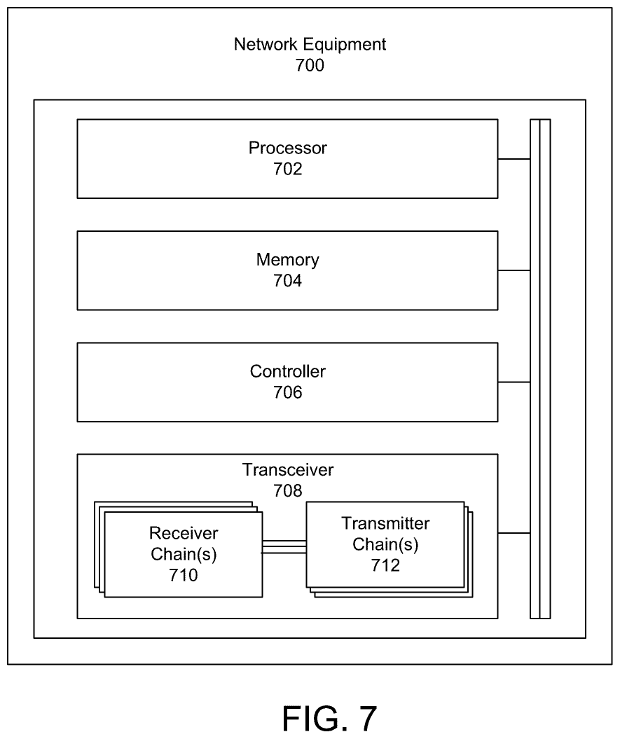

FIG. 7 illustrates an example of a NE 700 in accordance with aspects of the present disclosure. The NE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a CPU, an ASIC, an FPGA, or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the NE 700 to perform various functions of the present disclosure.

The memory 704 may include volatile or non-volatile memory. The memory 704 may store computer-readable, computer-executable code including instructions when executed by the processor 702 cause the NE 700 to perform various functions described herein. The code may be stored in a non-transitory computer-readable medium such the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the NE 700 to perform one or more of the RAN functions described herein (e.g., executing, by the processor 702, instructions stored in the memory 704). For example, the processor 702 may support wireless communication at the NE 700 in accordance with examples as disclosed herein.

In one example, the NE 700 is configured to configure a CSI-RS resource comprising a plurality of CSI-RS ports grouped into one or more CDM groups, generate, for the CSI-RS resource, a configuration message comprising one or more indicators defining a partial RE mapping in a time domain or a frequency domain, wherein the partial RE mapping specifies a quantity of REs for the at least one CDM group, wherein the quantity of REs is less than a quantity of CSI-RS ports of the at least one CDM group, and transmit the configuration message to a UE to enable the UE to receive and measure the CSI-RS according to the partial RE mapping.

In one example, the one or more indicators comprise at least one of a modified frequency-domain index set (k′) or a modified time-domain index set (l′) that overrides a default CSI-RS RE mapping. In one example, the one or more indicators comprise a codepoint, and the at least one processor is configured to cause the NE to map the codepoint to respective values of k′ and l′ defining the partial RE mapping.

In one example, the partial RE mapping corresponds to a new CSI-RS row index not present in a prior version of a CSI-RS configuration table. In one example, the new CSI-RS row index specifies a quantity of REs per CDM group that is less than a quantity of ports per CDM group of an existing CSI-RS row index.

In one example, determining the quantity of REs comprises selecting a subset of time-domain positions, frequency-domain positions, or both, relative to an anchor RE location of the at least one CDM group. In one example, the NE 700 is configured to select a CDM type for the CSI-RS resource based on the determined quantity of Res.

In one example, selecting the CDM type comprises modifying a predefined CDM sequence by omitting at least one time-domain or frequency-domain sequence index. In one example, the NE 700 is configured to determine the partial RE mapping based on at least one of a UE capability indicating support for partial RE mapping, a channel sparsity level, a mobility state of the UE, or a traffic demand condition.

In one example, the NE 700 is configured to configure the UE with a full-RE-mapping CSI-RS resource in addition to a partial-RE-mapping CSI-RS resource. In one example, the full-RE-mapping CSI-RS resource and the partial-RE-mapping CSI-RS resource are transmitted according to different periodicities.

In one example, the full-RE-mapping CSI-RS resource has a longer or sparser periodicity, and the partial-RE-mapping CSI-RS resource has a shorter or finer periodicity. In one example, the NE 700 is configured to apply the partial RE mapping only for selected slots or selected symbols according to a time-division multiplexing pattern.

In one example, the NE 700 is configured to resolve a collision between the CSI-RS resource and another CSI-RS resource by selecting one of the resources according to a priority based on periodicity, CSI-RS type, or reporting configuration. In one example, the one or more indicators further comprise a CSI-RS density value, and the at least one processor is configured to cause the NE to jointly determine a resource-block density and a CDM-group RE density for the CSI-RS resource.

In one example, the NE 700 is configured to dynamically adapt the partial RE mapping based on CSI measurement feedback received from the UE. In one example, the CSI-RS resource comprises at least 32, 48, 64, 128, or more CSI-RS ports, and the partial RE mapping is applied to support high-port-count multi-antenna transmission in a 6G multiple-input multiple-output (MIMO) system.

The controller 706 may manage input and output signals for the NE 700. The controller 706 may also manage peripherals not integrated into the NE 700. In some implementations, the controller 706 may utilize an operating system such as iOS®, ANDROID®, WINDOWS®, or other operating systems. In some implementations, the controller 706 may be implemented as part of the processor 702.

In some implementations, the NE 700 may include at least one transceiver 708. In some other implementations, the NE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas for receiving the signal over the air or wireless medium. The receiver chain 710 may include at least one amplifier (e.g., a low-noise amplifier (LNA)) configured to amplify the received signal. The receiver chain 710 may include at least one demodulator configured to demodulate the received signal and obtain the transmitted data by reversing the modulation technique applied during transmission of the signal. The receiver chain 710 may include at least one decoder for decoding/processing the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

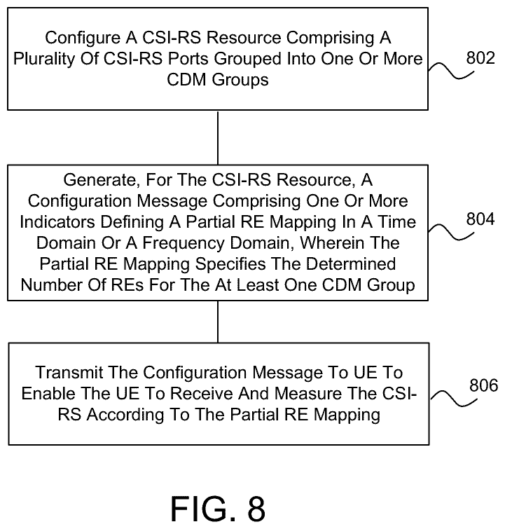

FIG. 8 illustrates a flowchart of a method performed by an NE 700 in accordance with aspects of the present disclosure. The operations of the method may be implemented by an NE 700 as described herein. In some implementations, the NE 700 may execute a set of instructions to control the function elements of the NE 700 to perform the described functions.

At step 802, the method may configure a CSI-RS resource comprising a plurality of CSI-RS ports grouped into one or more CDM groups. The operations of step 802 may be performed in accordance with examples as described herein. In some implementations, aspects of the operations of step 802 may be performed by an NE 700, as described with reference to FIG. 7.

At step 804, the method may generate, for the CSI-RS resource, a configuration message comprising one or more indicators defining a partial RE mapping in a time domain or a frequency domain, wherein the partial RE mapping specifies the determined quantity of REs for the at least one CDM group. The operations of step 804 may be performed in accordance with examples as described herein. In some implementations, aspects of the operations of step 804 may be performed by an NE 700, as described with reference to FIG. 7.

At step 806, the method may transmit the configuration message to UE to enable the UE to receive and measure the CSI-RS according to the partial RE mapping. The operations of step 806 may be performed in accordance with examples as described herein. In some implementations, aspects of the operations of step 806 may be performed by an NE 700, as described with reference to FIG. 7.

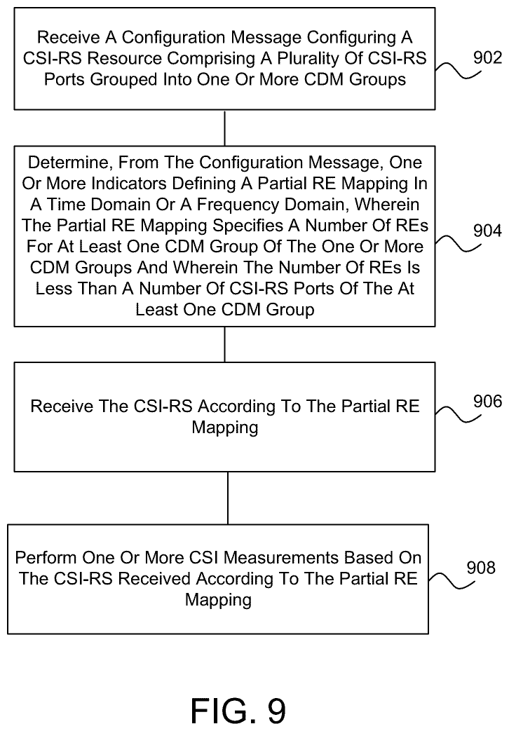

FIG. 9 illustrates a flowchart of a method performed by a UE 500 in accordance with aspects of the present disclosure. The operations of the method may be implemented by a UE 500 as described herein. In some implementations, the UE 500 may execute a set of instructions to control the function elements of the UE 500 to perform the described functions.

At step 902, the method may receive a configuration message configuring a CSI-RS resource comprising a plurality of CSI-RS ports grouped into one or more CDM groups. The operations of step 902 may be performed in accordance with examples as described herein. In some implementations, aspects of the operations of step 902 may be performed by a UE 500, as described with reference to FIG. 5.

At step 904, the method may determine, from the configuration message, one or more indicators defining a partial RE mapping in a time domain or a frequency domain, wherein the partial RE mapping specifies a quantity of REs for at least one CDM group of the one or more CDM groups and wherein the quantity of REs is less than a quantity of CSI-RS ports of the at least one CDM group. The operations of step 904 may be performed in accordance with examples as described herein. In some implementations, aspects of the operations of step 904 may be performed by a UE 500, as described with reference to FIG. 5.

At step 906, the method may receive the CSI-RS according to the partial RE mapping. The operations of step 906 may be performed in accordance with examples as described herein. In some implementations, aspects of the operations of step 906 may be performed by a UE 500, as described with reference to FIG. 5.

At step 908, the method may perform one or more CSI measurements based on the CSI-RS received according to the partial RE mapping. The operations of step 908 may be performed in accordance with examples as described herein. In some implementations, aspects of the operations of step 908 may be performed by a UE 500, as described with reference to FIG. 5.

It should be noted that the method described herein describes one possible implementation, and that the operations and the steps may be rearranged or otherwise modified and that other implementations are possible.

As used herein, the term “partial resource-element mapping” or “partial RE mapping” refers to a CSI-RS mapping configuration in which the number or quantity of RES allocated to a CDM group is less than the number or quantity of CSI-RS ports associated with that CDM group. By contrast, the term “full resource-element mapping” or “full RE mapping” refers to a configuration in which the number or quantity of REs allocated to a CDM group is equal to the number or quantity of CSI-RS ports of that CDM group, consistent with existing CSI-RS configurations in current NR specifications.

The term “CDM group” refers to a subset of CSI-RS antenna ports that share a common CDM sequence for the purpose of establishing orthogonality during CSI-RS transmission. The term “CDM type” refers to the pattern, dimensionality, and sequence structure used for orthogonalizing ports within a CDM group, such as fd-CDM2, cdm4-FD2-TD2, or cdm8-FD2-TD4. In some implementations, a CDM type may be modified or truncated to align with partial RE mapping configurations.

The terms “k′” and “1′” refer to modified frequency-domain and time-domain index sets, respectively, that define specific RE positions within a slot for CSI-RS transmission. These modified index sets may override or replace the default index sets associated with a CSI-RS resource in Table 7.4.1.5.3-1 of TS 38.211. The term “codepoint” refers to a signaling value that corresponds to a predefined set of such mapping parameters, and “codepoint mapping” refers to the association between a transmitted codepoint and the RE index sets the UE applies.

The term “CSI-RS density” refers to the proportion of REs or RBs within a time-frequency region that are used for CSI-RS transmission. CSI-RS density may refer to coarse RB-level allocation density (e.g., allocation to every RB, every other RB, or every Nth RB) or fine-granularity RE-level density resulting from variations in k′ and l′. The term “CSI-RS resource” refers to a set of CSI-RS ports, CDM groups, mapping indices, periodicity values, offsets, and other parameters that collectively define a CSI-RS transmission occasion.

The term “override signaling” refers to signaling from the NE that updates or replaces default CSI-RS mapping parameters, such as k′, l′, CDM type, or density, for a given CSI-RS resource. The term “collision” between CSI-RS resources refers to overlapping transmission occasions in which two CSI-RS resources map to one or more common REs. The term “collision resolution” refers to the rules or prioritization strategies applied by the UE when selecting which CSI-RS resource to receive in the event of a collision.

The term “high-port-count MIMO” refers to multiple-input multiple-output configurations that support large numbers of CSI-RS antenna ports (e.g., 32, 48, 64, 128, or more). High-port-count MIMO systems may benefit from the techniques described herein because CSI-RS overhead grows with port count under full RE mapping.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network equipment (NE) for wireless communication, comprising:
at least one memory; and
at least one processor coupled with the at least one memory and configured to cause the NE to:
configure a channel state information reference signal (CSI-RS) resource comprising a plurality of CSI-RS ports grouped into one or more code-division multiplexing (CDM) groups;
generate, for the CSI-RS resource, a configuration message comprising one or more indicators defining a partial resource element (RE) mapping in a time domain or a frequency domain, wherein the partial RE mapping specifies a quantity of REs for the at least one CDM group, wherein the quantity of REs is less than a quantity of CSI-RS ports of the at least one CDM group; and
transmit the configuration message to a user equipment (UE) to enable the UE to receive and measure the CSI-RS according to the partial RE mapping.

2. The NE of claim 1, wherein the one or more indicators comprise at least one of a modified frequency-domain index set (k′) or a modified time-domain index set (l′) that overrides a default CSI-RS RE mapping.

3. The NE of claim 1, wherein the one or more indicators comprise a codepoint, and the at least one processor is configured to cause the NE to map the codepoint to respective values of k′ and l′ defining the partial RE mapping.

4. The NE of claim 1, wherein the partial RE mapping corresponds to a new CSI-RS row index not present in a prior version of a CSI-RS configuration table.

5. The NE of claim 4, wherein the new CSI-RS row index specifies a quantity of REs per CDM group that is less than a quantity of ports per CDM group of an existing CSI-RS row index.

6. The NE of claim 1, wherein the at least one processor is configured to cause the NE to determine the quantity of REs by selecting a subset of time-domain positions, frequency-domain positions, or both, relative to an anchor RE location of the at least one CDM group.

7. The NE of claim 1, wherein the at least one processor is configured to cause the NE to select a CDM type for the CSI-RS resource based on the determined quantity of REs.

8. The NE of claim 7, wherein selecting the CDM type comprises modifying a predefined CDM sequence by omitting at least one time-domain or frequency-domain sequence index.

9. The NE of claim 1, wherein the at least one processor is configured to cause the NE to determine the partial RE mapping based on at least one of a UE capability indicating support for partial RE mapping, a channel sparsity level, a mobility state of the UE, or a traffic demand condition.

10. The NE of claim 1, wherein the at least one processor is configured to cause the NE to configure the UE with a full-RE-mapping CSI-RS resource in addition to a partial-RE-mapping CSI-RS resource.

11. The NE of claim 10, wherein the full-RE-mapping CSI-RS resource and the partial-RE-mapping CSI-RS resource are transmitted according to different periodicities.

12. The NE of claim 11, wherein the full-RE-mapping CSI-RS resource has a longer or sparser periodicity, and the partial-RE-mapping CSI-RS resource has a shorter or finer periodicity.

13. The NE of claim 1, wherein the at least one processor is configured to cause the NE to apply the partial RE mapping only for selected slots or selected symbols according to a time-division multiplexing pattern.

14. The NE of claim 1, wherein the at least one processor is configured to cause the NE to resolve a collision between the CSI-RS resource and another CSI-RS resource by selecting one of the resources according to a priority based on periodicity, CSI-RS type, or reporting configuration.

15. The NE of claim 1, wherein the one or more indicators further comprise a CSI-RS density value, and the at least one processor is configured to cause the NE to jointly determine a resource-block density and a CDM-group RE density for the CSI-RS resource.

16. The NE of claim 1, wherein the at least one processor is configured to cause the NE to dynamically adapt the partial RE mapping based on CSI measurement feedback received from the UE.

17. The NE of claim 1, wherein the CSI-RS resource comprises at least 32, 48, 64, 128, or more CSI-RS ports, and the partial RE mapping is applied to support high-port-count multi-antenna transmission in a 6G multiple-input multiple-output (MIMO) system.

18. A method of a network equipment (NE), comprising:
configuring a channel state information reference signal (CSI-RS) resource comprising a plurality of CSI-RS ports grouped into one or more code-division multiplexing (CDM) groups;
generating, for the CSI-RS resource, a configuration message comprising one or more indicators defining a partial resource element (RE) mapping in a time domain or a frequency domain, wherein the partial RE mapping specifies a quantity of REs for the at least one CDM group, wherein the quantity of REs is less than a quantity of CSI-RS ports of the at least one CDM group; and
transmitting the configuration message to a user equipment (UE) to enable the UE to receive and measure the CSI-RS according to the partial RE mapping.

19. A user equipment (UE) for wireless communication, comprising:
at least one memory; and
at least one processor coupled with the at least one memory and configured to cause the UE to:
receive a configuration message configuring a channel state information reference signal (CSI-RS) resource comprising a plurality of CSI-RS ports grouped into one or more code-division multiplexing (CDM) groups;
determine, from the configuration message, one or more indicators defining a partial resource-element (RE) mapping in a time domain or a frequency domain, wherein the partial RE mapping specifies a quantity of REs for at least one CDM group of the one or more CDM groups and wherein the quantity of REs is less than a quantity of CSI-RS ports of the at least one CDM group;
receive the CSI-RS according to the partial RE mapping; and
perform one or more CSI measurements based on the CSI-RS received according to the partial RE mapping.

20. A method of a user equipment (UE), comprising:
receiving a configuration message configuring a channel state information reference signal (CSI-RS) resource comprising a plurality of CSI-RS ports grouped into one or more code-division multiplexing (CDM) groups;
determining, from the configuration message, one or more indicators defining a partial resource-element (RE) mapping in a time domain or a frequency domain, wherein the partial RE mapping specifies a quantity of REs for at least one CDM group of the one or more CDM groups and wherein the quantity of REs is less than a quantity of CSI-RS ports of the at least one CDM group;
receiving the CSI-RS according to the partial RE mapping; and
performing one or more CSI measurements based on the CSI-RS received according to the partial RE mapping.
